(19) United States
(12) Patent Application Publication
(10) Pub. No.: US 2021/0209152 A1
(43) Pub. Date: Jul. 8, 2021

(54) IMAGE DATA STORAGE DEVICE, IMAGE DATA STORAGE METHOD, AND A NON-TRANSITORY COMPUTER-READABLE STORAGE MEDIUM

(71) Applicant: CANON KABUSHIKI KAISHA, Tokyo (JP)

(72) Inventor: Masanori Fukada, Tokyo (JP)

(21) Appl. No.: 17/210,272

(22) Filed: Mar. 23, 2021

Related U.S. Application Data
(63) Continuation of application No. PCT/JP2019/035629, filed on Sep. 11, 2019.

(30) Foreign Application Priority Data
Sep. 27, 2018 (JP) 2018-182086

(51) Int. Cl. G06F 16/51; G06F 16/583; G06F 16/587

(52) U.S. Cl. CPC G06F 16/51; G06F 16/587; G06F 16/583

(57) ABSTRACT

An image data storage device 101 acquires a plurality of images (step S201), identifies metadata common among two or more images of the plurality of images (step S205), and stores the plurality of images into an image file conforming to an image file format and also stores the common metadata into the image file (step S210).

### CROSS-REFERENCE TO RELATED APPLICATIONS

This application is a Continuation of International Patent Application No. PCT/JP2019/035629, filed Sep. 11, 2019, which claims the benefit of Japanese Patent Application No. 2018-182086 filed Sep. 27, 2018, both of which are hereby incorporated by reference herein in their entirety.

### BACKGROUND OF THE INVENTION

### Field of the Invention

The present invention relates to an image data storage device, image data storage method, and a non-transitory computer-readable storage medium.

### Background Art

The Moving Picture Experts Group (MPEG) has developed a standard for storing a single still image, a plurality of still images, or an image sequence (e.g., a burst of still images) into a single file. This standard is referred to as High Efficiency Image File Format (HEIF), which enables the interchange, editing, and display of images and image sequences. The HEIF is a storage format extended based on tools provided in international Organization for Standardization (ISO) Base Media File Format (ISOBMFF). HEIF has been standardized to the name of “Image File Format” in ISO/International Electrotechnical Commission (IEC) 23008-12. HEIF specifies a normative structure including metadata, and also specifies a method for associating metadata with an image, and a configuration of metadata in a specific format. PTL1 discusses a technique for storing derivative images into an image file conforming to HEIF.

In contrast, in recent years, image generation devices, such as a camera and a smartphone, have various functions and thus can generate various information, including not only an age capturing date and time, an image size, and an image quality, but also information obtained during image capturing, and metadata corresponding to captured image data. For example, information about a location where image data is captured, information for identifying an object or a scene in image data, and various information associated with image data, such as an image capturing mode used during image capturing, are generated together with image data. These pieces of information about image data can be stored as metadata in an HEIF file.

### CITATION LIST

### Patent Literature

PTL1: U.S. Patent Laid-Open No. 2016/0371265, Specification

In a case where two or more images of a plurality of images stored in an image file (e.g., an HEIF file) conforming to a predetermined image format correspond to common metadata, it is difficult to effectively perform the processing.

Specifically, even when the same metadata is applied to two or more images stored in the HEIF file, the metadata is stored for each image. Thus, a device that processes the HEIF file cannot determine whether metadata corresponding to each image is common without sequentially checking the metadata corresponding to each image and configuration information about the metadata. In a case where all of a plurality of images in the HEIF file correspond to common metadata, or in a case where two or more of the plurality of images correspond to common metadata, the processing load for collectively performing processing on each image becomes large, accordingly.

For example, in a case where a single image is divided into tiles and each tile image is stored as a derivative image, it is not efficient to define metadata, such as Exchangeable image file format (Exif) data, for each derivative image, from a view point of file generation load and file size. In other words, despite the fact that metadata (e.g., an image size, color information, and encoding information) corresponding to each tile image is common in many cases, metadata has heretofore been defined for each of a plurality of (derivative) images, which is not efficient.

### SUMMARY OF THE INVENTION

An object of the present invention is to make it possible to effectively perform processing on an image file, in a case where two or more images of a plurality of images stored in the image file conforming to a predetermined file format correspond to common metadata.

To solve the above-described issue, an image data storage device according to the present invention includes, for example, the configuration described below. That is to say, an image data storage device that stores a plurality of images in an image file conforming to an image file format includes an acquisition unit configured to acquire the plurality of images, an identification unit configured to identify metadata common among two or more of the plurality of images acquired by the acquisition unit, a storage unit configured to store the plurality of images acquired by the acquisition unit in the image file conforming to the image file format and to store the metadata identified by the identification unit as common metadata in the image file conforming to the image file format, and an output unit configured to output the image file in which the plurality of images and the metadata are stored by the storage unit.

Further features of the present invention will become apparent from the following description of exemplary embodiments with reference to the attached drawings.

### BRIEF DESCRIPTION OF DRAWINGS

FIG. 1 illustrates a configuration of an image data storage device according to an exemplary embodiment.

FIG. 2 is a flowchart illustrating a processing flow of the image data storage device according to the exemplary embodiment.

FIG. 3 illustrates an example of a file format according to the exemplary embodiment,

FIG. 4 illustrates an example of Exchangeable Image File Format (EXIF) data according to the exemplary embodiment.

FIG. 5 illustrates a configuration of an image data storage device according to the exemplary embodiment.

FIG. 6 is a flowchart illustrating a processing flow of the image data storage device according to the exemplary embodiment.

FIG. 7 illustrates an example of a common item property box structure in the file format according to the exemplary embodiment.

FIG. 8 illustrates an example of a common item property group box structure in an image file format according to the exemplary embodiment.

FIG. 9 illustrates an example of the common item property box structure in the image file format according to the exemplary embodiment.

FIG. 10 illustrates an example of the common item property group box structure in the image file format according to the exemplary embodiment,

FIG. 11 illustrates an example of the item property box structure in the image file format according to the exemplary embodiment.

FIG. 12 illustrates an example of an item property association box structure in the image file format according to the exemplary embodiment.

FIG. 13 illustrates an example of the item property association group box structure in the image file format according to the exemplary embodiment.

FIG. 14 illustrates an example of an item reference box in the image file format according to the exemplary embodiment.

FIG. 15 illustrates an example of an item information box in the image file format according to the exemplary embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Exemplary Embodiment

A first exemplary embodiment of the present invention will be described with reference to the drawings, Not all combinations of features described in the following exemplary embodiments are essential to the present invention.

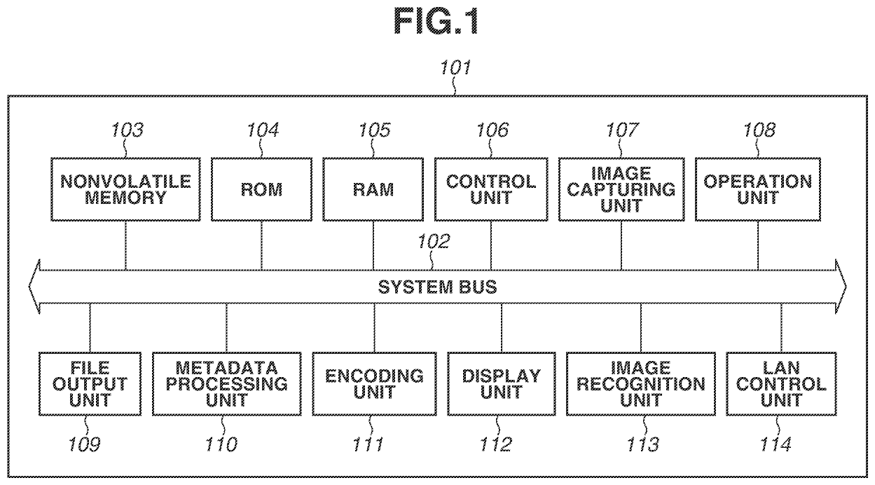

FIG. 1 illustrates a configuration of an image data storage device 101 according to the present exemplary embodiment. The image data storage device 101 illustrated in FIG. 1 is a device having an image capturing function of, for example, a camera, a smartphone, or a tablet personal computer (PC). The image data storage device 101 according to the present exemplary embodiment functions as a file generation device that generates an image file conforming to an image file format. The image data storage device 101 includes a system bus 102, and also includes a nonvolatile memory 103, a read-only memory (ROM) 104, a random access memory (RAM) 105, a control unit 106, an image capturing unit 107, and an operation unit 108. The image data storage device 101 further includes a file output unit 109, a metadata processing unit 110, an encoding unit 111, a display unit 112, an image recognition unit 113, and a local area network (LAN) control unit 114. Each of these units has a hardware configuration to be connected to the system bus 102. The system bus 102 transmits data between blocks connected thereto. The term “image” is mainly used in the present exemplary embodiment, but it is not intended to limit the term to a still image.

Programs to be executed by the control unit 106 include an operating system (OS), a driver, and an application. The control unit 106 controls an overall operation of the image data storage device 101, and performs processing for, for example, changing display of the display unit 112, sending an image capturing instruction to the image capturing unit 107, and sending a connection instruction to the LAN control unit 114, based on an instruction input by a user using the operation unit 108. The image capturing unit 107 includes an image sensor, such as a complementary metal-oxide semiconductor (CMOS) sensor, and inputs an image signal according to an instruction from the control unit 106. The encoding unit 111 encodes the input image signal into digital data. The encoding unit 111 also decodes an image file stored in the nonvolatile memory 103. Typically, the image data storage device 101 decodes the image file according to a user operation related to playback processing, and causes the display unit 112 to display the decoded image data.

The metadata processing unit 110 acquires data encoded by the encoding unit 111, and generates an image file conforming to a predetermined file format (e.g., High Efficiency Image File Format (HEIF)). The metadata processing unit 110 can generate not only a file conforming to HEIF, but also a file conforming to, for example, other moving image file formats specified in Moving Picture Experts Group (MPEG), or a format, such as Joint Photographic Experts Group (JPEG). The metadata processing unit 110 can also acquire encoded data from a device other than the encoding unit 111 and generate an image file.

The file output unit 109 outputs the image file generated by the metadata processing unit 110. An output destination of the file output unit 109 is not particularly limited. For example, the image file may be output to a display device that display an image based on the image file, or a printing device that prints an image based on the image file. Alternatively, the image file may be output to a storage device that stores the image file, or a storage medium (nonvolatile memory 103) that stores the image file. The nonvolatile memory 103 is, for example, a Secure Digital (SD) card, CompactFlash®, or a flash memory. The image recognition unit 113 executes recognition processing on, for example, a person, an object, and a scene based on an image signal input from the image capturing unit 107, or an image file stored in the nonvolatile memory 103, and sends the result (scene information or object information) to the control unit 106. The control unit 106 sends an instruction to the display unit 112, or sends an automatic shutter releasing instruction or the like to the image capturing unit 107, based on the recognition processing result. The control unit 106 performs processing for, for example, notifying the metadata processing unit 110 of metadata stored in the image file. The present exemplary embodiment is described assuming that the terms “metadata” and “property information” have substantially the same meaning.

In the present exemplary embodiment, functional blocks are configured using different circuits, but instead processing (operation) of at least one functional block may be implemented by program execution of a central processing unit (CPU) or the like.

The RAM 105 is a main storage unit for the image data storage device 101, and is mainly used as a temporary data storage area when processing of each functional block is executed. The ROM 104 is a nonvolatile storage unit that stores software programs to be executed by each functional block. The programs stored in the ROM 104 are transferred to the RAM 105 and are read out and executed by each functional block. The LAN control unit 114 is a communication interface for connecting to a LAN, and executes communication control using a wired LAN or wireless LAN. For example, in a case where the image data storage device 101 is connected to another device via a wired LAN, the LAN control unit 114 includes transmission media physical (PHY) and media access control (MAC) (transmission media control) hardware circuits. In this case, the LAN control unit 114 corresponds to an Ethernet® Network Interface Card (NIC). In a case where the image data storage device 101 is connected to another device via a wireless LAN, the LAN control unit 114 includes a controller for executing control of a wireless LAN conforming to, for example, Institute of Electrical and Electronics Engineers (IEEE) 802.11a/b/g/n/ac, a radio frequency (RF) circuit, and an antenna.

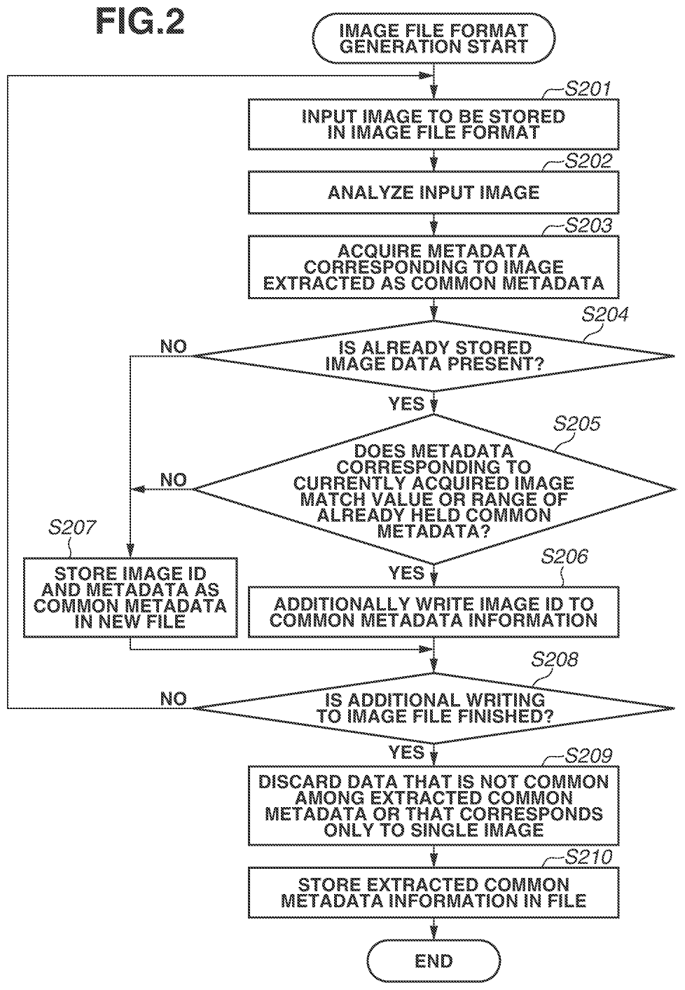

Next, a processing flow for generating an image file conforming to an image file format (HEIF) will be described with reference to FIG. 2. This processing flow is started by a user operation. As described above, this processing flow may be executed by each circuit illustrated in FIG. 1, or may be executed by the CPU.

In step S201, an image signal acquired by the image capturing unit 107 is encoded by the encoding unit 111, and the encoded image signal is input to the metadata processing unit 110. The image data storage device 101 can acquire image signals corresponding to a plurality of images. For example, when the image capturing unit 107 executes burst shooting (continuous shooting), a plurality of continuously captured images is acquired. When an image captured by the image capturing unit 107 is divided into tiles and each tile is encoded by the encoding unit 111, tile images are acquired as a plurality of images. Examples of a method for dividing an image into tiles and encoding each tile include a method using tile coding specified in High Efficiency Video Coding (HEVC), a method for individually encoding divided areas, and other methods, and the method is not limited. The image data storage device 101 can acquire one or more images not only from the image capturing unit 107, but also from other devices.

In step S202, the metadata processing unit 110 analyzes metadata corresponding to the encoded image signal. In step S203, the metadata processing unit 110 acquires metadata corresponding to the image acquired in step S201. A case will be described where the metadata processing unit 110 acquires, for example, an image file conforming to international Organization for Standardization (ISO) Base Media File Format (ISOBMFF) as the encoded image signal. In this case, the metadata processing unit 110 acquires property information to be stored in an item property box (iprp) within the image file, and property information to be referenced by an item in an image property association box.

In the case of acquiring, for example, an image file including Exif data as the encoded image signal, the metadata processing unit 110 acquires Exif data. The data to be acquired is not limited to Exif data. Metadata and the like specified in Extensible Metadata Platform (XMP) and MPEG-7 may be acquired. Alternatively, for example, a part of Exif data may be acquired in step S203.

Image information recognized by the image recognition unit 113 may be used as metadata. For example, the image recognition unit 113 may recognize, the type of a scene for an image, or whether a specific object is included in an image, and may acquire the result (scene recognition result or object information) as metadata, Metadata based on the recognition processing result can also be used as common metadata.

In step S204, the metadata processing unit 110 determines whether one or more images are already present in an HEIF file. If one or more images are present (YES in step S204), the processing proceeds to step S205. If one or more images are not present (NO in step S204), the processing proceeds to step S207. In step S205, the metadata processing unit 110 determines whether the metadata already stored in the HEIF file matches the metadata corresponding to the currently acquired image. If these metadata match (YES in step S205), the processing proceeds to step S206, and the metadata processing unit 110 associates an item ID (image identification information) for the currently acquired image with the common metadata already stored in the HEIF file. In contrast, if the processing proceeds to step S207 from step S204 (NO in step S204), the metadata processing unit 110 associates the item ID for the currently acquired image with the metadata for the currently acquired image, and stores the item ID and the metadata in a new HEIF file. If the processing proceeds to step S207 from step S205 (NO in step S205), the metadata processing unit 110 associates the item ID for the currently acquired image with the metadata for the currently acquired image, and stores the item ID and the metadata in the generated HEIF file.

It may be determined whether to use all or some of the metadata as common metadata based on any setting. For example, only Exif data may be used as common metadata, or only metadata in the image property association box may be used as common metadata. More alternatively, only information about an image capturing date and time may be used as common metadata.

In step S208, the metadata processing unit 110 determines whether there is an unprocessed image. If there is no unprocessed image (YES in step S208), the processing proceeds to step S209. If there is an unprocessed image (NO in step S208), the processing returns to step S201. The determination in step S208 can be made based on, for example, a setting (e.g., the number of images captured by burst shooting) for image capturing conditions, a user's setting for the number of images, and other predetermined conditions.

In step S209, the metadata processing unit 110 deletes, from a storage area for common metadata, metadata that is not common among the two or more images. In the present exemplary embodiment, metadata that is not common among the two or more images is deleted, but instead, for example, a threshold other than “2” may be used to determine whether to delete metadata.

In some cases, metadata corresponding only to a single image may be stored in the storage area for common metadata. This configuration is effective, for example, in a case where only one image is stored in the HEI file, or in a use case where an image item where specific metadata is recorded is to be promptly retrieved. In other words, information stored in the storage area for common metadata can be used as an index for an image associated with specific metadata.

In step S210, the metadata processing unit 110 stores common metadata in the HEIF file. The common metadata may be stored in the HEIF file in step S206 or step S207.

If the storage of common data in the HEIF file eliminates the need for metadata corresponding to each image, the metadata processing unit 110 deletes the metadata from the HEIF file. For example, if the item property association is divided into groups, the item property association for each item is not required and thus is deleted.

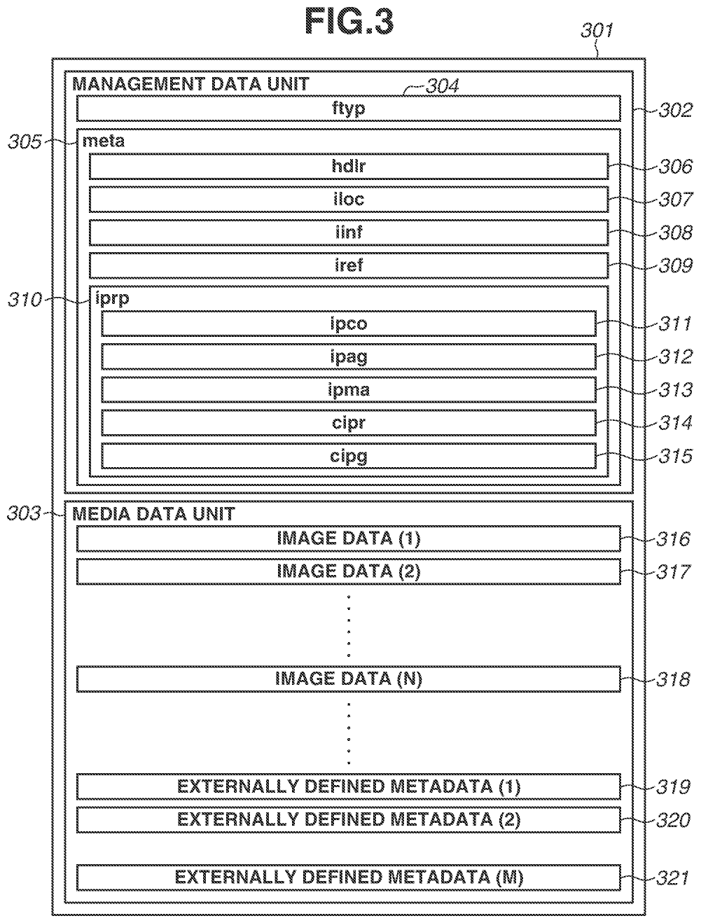

Next, a configuration example of a format for the HEIF file generated by the image data storage device 101 will be described with reference to FIG. 3. Reference numeral 301 denotes the entire HEIF file. The HEIF file of a general and simple format is composed of a management data unit 302 and a media data unit 303, The management data unit 302 stores file management data including information about encoding of media data, and information about a method for storing data into the HEIF file. The media data unit 303 stores, for example, data (media data) obtained by encoding content data (moving images, still images, and audio), and metadata for referring to external standards. In the media data unit 303, encoded images, Exif data, and the like are stored in a box called a MediaDataBox. Storage areas 316, 31.7, and 318 are storage areas for storing each image. Storage areas 319, 320, and 321 are storage area for storing metadata, such as Exif data, which is defined by external standards. The management data unit 302 has a box structure, and each box is identified by a type identifier, A box 301 is a FileTypeBox identified by an identifier ftyp. The FileTypeBox is used to identify the type of a file, and the file format is identified using an identifier of four characters called “brand”. The HEIF file is represented by an identifier of four characters, such as “mif1” or “msf1”, for identifying “brand”. A box 305 is referred to as a MetaBox and is identified by an identifier meta. In the box 305, various boxes are stored. For example, the box 305 includes a box for storing untimed metadata, such as an image (image item) and a metadata item related to the image (image item). A box 306 is referred to as a HandlerReferenceBox and is identified by an identifier hdlr. The structure or format of a content included in the MetaBox 305 is identified depending on a handler type in the HandlerReferenceBox. In the HEIF file, an identification code of four characters “pict” is applied to this handler type. A box 307 is referred to as an ItemLocationBox and is identified by an identifier iloc. In the ItemLocationBox 307, information indicating an ID (identification information about each image) for each item and a storage location (location) are described. The metadata processing unit 110 can recognize, by referring to the information, a location where data on each item defined by the management data unit 302 is present. A box 308 is referred to as an ItemInformationBox and is identified by an identifier iinf. In the box 308, an ItemInformationEntry is defined for each item, and information indicating, for example, an item ID, an item type, and an item name is stored in this entry. A box 309 is referred to as an ItemReferenceBox and is identified by an identifier iref. In the ItemReferenceBox 309, items having a reference relationship are associated with each other, and information indicating a reference type or the like is stored. If a single item is configured by referring to a plurality of items, item IDs to be referenced are sequentially described. For example, when a thumbnail image for an item 1 corresponds to an item 2, “throb” representing a thumbnail image is stored as the reference type. The item ID indicating the item 1 is stored in a from_item_id, and the item ID indicating the item 2 is stored in a to_item_id.

When a single image is divided into a plurality of tiles and the tiles are stored in the HEIF file, information indicating the association between the tiles is stored. For example, assume that the entire image corresponds to the item 1 and a plurality of tile images corresponds to items 2, 3, 4, and 5. In this case, information indicating that the item 1 is an image formed by the item 2, the item 3, the item 4, and the item 5 is stored. Specifically, “dimg” representing a derivative image is stored as the reference type, and the ID indicating the item 1 is stored in the from_item_id. All the item IDs indicating the item 2, the item 3, the item 4, and the item 5, respectively, are stored in the to_ite_id. With this configuration, information for reconfiguring a plurality of image items, which is obtained by dividing an image into tiles, into one image is indicated.

The ItemReferenceBox can also be used to describe a reference relationship between metadata, such as Exif data, which is defined by external standards, and image items. In this case, “cdsc” is used as the reference type, in the from_item_id, the item ID indicating Exif data is stored, and in the to_item_id, the item ID indicating image item is stored. A box 310 is referred to as an ItemPropertyBox and is identified by an iprp identifier. In the box 310, property information to be applied to each item and a method for configuring the property are stored. A box 311 is referred to as an ImagePropertyContainerBox and is identified by an identifier ipco. In the box 311, a box for describing each property is stored. The box 311 includes various boxes. For example, a box indicating the size of an image, a box indicating color information, a box indicating pixel information, a box for storing HEVC parameters, and the like are stored, as needed. These file formats are common to the box structure specified in ISO/International Electrotechnical Commission (IEC) 23008-12.

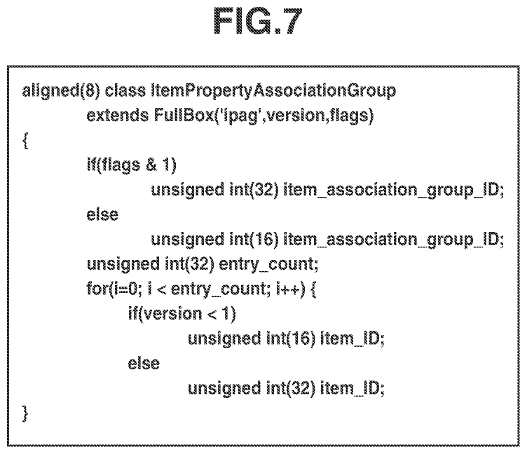

A box 312 is referred to as an ItemPropertyAssociationGroupBox and is identified by an ipag identifier. The box 312 is defined by a structure illustrated in FIG. 7. The box 312 is a box for grouping the association of ItemProperty for each item defined as an entry in an ItemPropertyAssociationBox specified in ISO/IEC 23008-12. The use of the ItemPropertyAssociationGroupBox enables grouping of the items to which a common item property is applied, Each item group can be identified by an item_association_group_id.

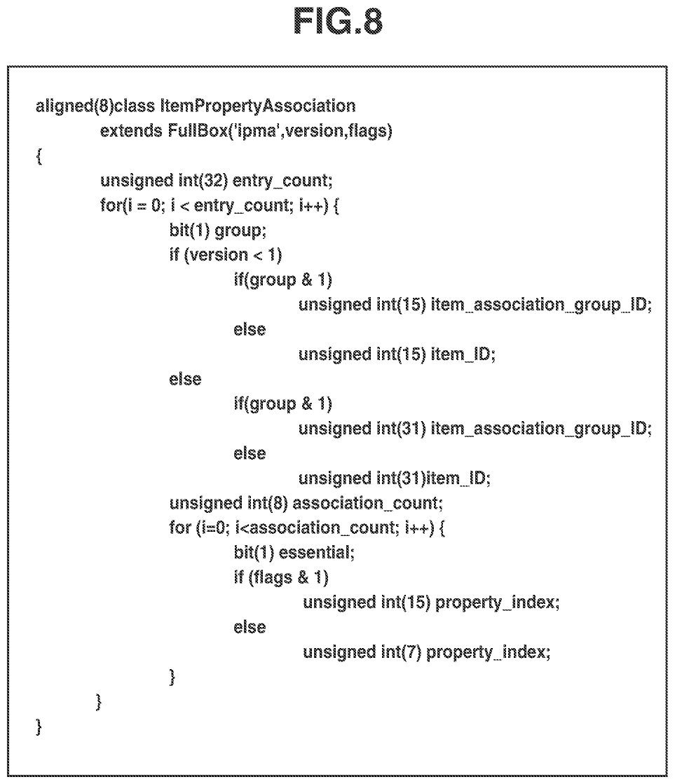

A box 313 is referred to as an ItemPropertyAssociationBox and is identified by an ipma identifier. The box 313 is defined by a structure illustrated in FIG. 8. In the case of describing the configuration of the item property for each item, a group bit is set to “0” and indices for properties to be applied to the item are sequentially described.

In contrast, the group bit “1” is set to each item grouped using the ItemPropertyAssociationGroupBox so as to make clear that the property configuration for each item group is described. Further, property configurations to be applied to each group identified by the item_association_group_ID are sequentially described, With this configuration, unlike in the structure of related art in which all item configurations are described for each item, the items to which common properties are applied can be grouped and the item configuration can be described for each group. This leads to a reduction in the amount of data to be described in the file format. In the present exemplary embodiment, the box illustrated in FIG. 7 is newly defined. However, the grouping and describing method may similarly be employed by using an EntityToGroupBox specified in ISO/IEC 23008-12 and extending the box illustrated in FIG. 8 according to the EntityToGroupBox.

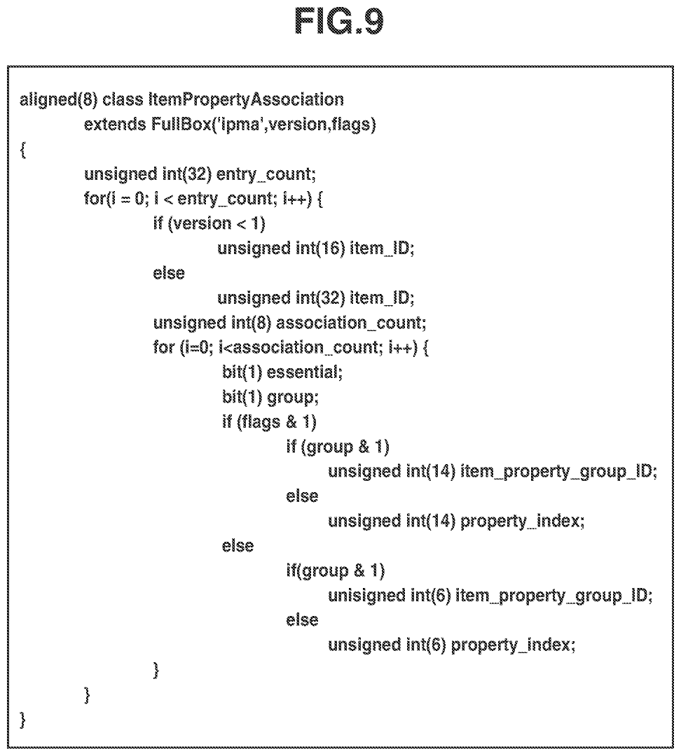

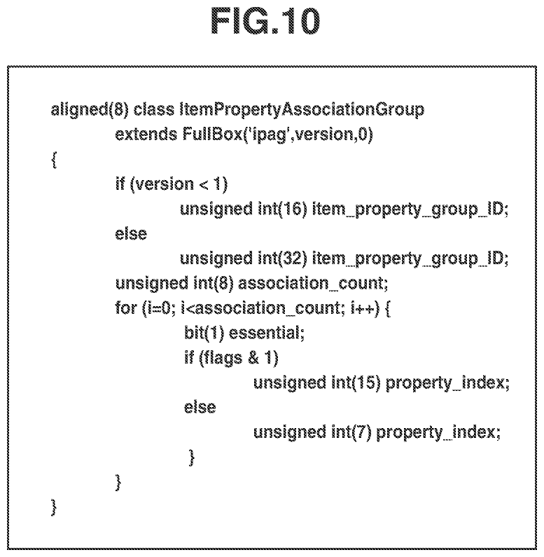

In the box structure illustrated in FIG. 7 according to the present exemplary embodiment, the number of bits to be used can be reduced, and thus the structure can be applied more effectively. On the other hand, an object to define grouping of items can be achieved by using the existing EntityToGroupBox. In this case, a new grouping_type is defined. Since the present exemplary embodiment illustrates an example of grouping of item properties, grouping of items is defined in the ItemPropertyBox. While the present exemplary embodiment described above illustrates a method for effectively describing an item configuration by the above-described method, box structures illustrated in FIGS. 9 and 10 may also be adopted as modified examples. This method is not for grouping of items, but for grouping item properties to be applied and describing the item properties. Specifically, in this method, a part of property information to be described for each item is described as a property group. The box structure illustrated in FIG. 10 is defined in the ItemPropertyBox in the present exemplary embodiment, but instead the box structure may be defined in a GroupListBox specified in ISO/IEC 23008-12. With this configuration, the amount of data to be described in the file format can be reduced.

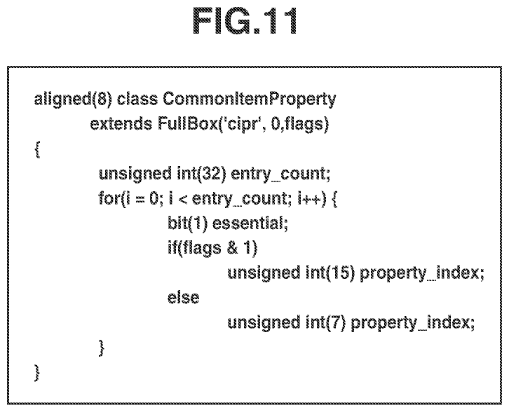

In the present exemplary embodiment, each box structure is defined as described above, to thereby reduce the amount of data to be described in an image tile. However, any other box structure may be used, as long as a method for grouping and defining metadata (properties) to be applied to two or more items (image items) is employed. Further, a data structure that is handled as an entry in a box may be defined and stored as another box. A box 314 is referred to as a CommonItemPropertyBox and is identified by a cipr identifier. The box 314 is defined by a structure illustrated in FIG. 11. The box 314 is a box for representing item properties to be applied in common to all items. The use of the box 314 facilitates extraction of properties (metadata) to be applied in common to all items. In other words, if common metadata is stored using the CommonItemPropertyBox, the common metadata can be extracted without the need for searching for all entries in the ItemPropertyAssociationBox. This leads to an improvement in search efficiency during file access.

The present exemplary embodiment described above illustrates an example where a box representing a property to be applied in common to all items is defined to thereby improve the search efficiency. However, the present exemplary embodiment is not limited to this example. Information for identifying the application to all items as described above may be stored in each item property box defined in an ItemPropertyContainerBox.

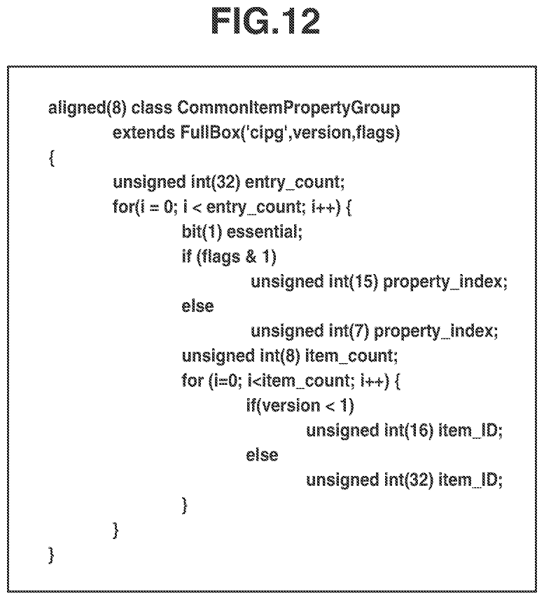

A box 315 is referred to as a CommonItemPropertyGroupBox and is identified by an identifier cipg. The box 315 is defined by a structure illustrated in FIG. 12. The box 315 is a box that makes it possible to identify items to which common properties (metadata) are applied. In other words, the box 315 is a box for describing a list of items to which the common properties are applied. The use of the box 315 enables the metadata processing unit 110 to identify each item to which a specific property is applied, without the need for checking all entries in the ItemPropertyAssociationBox. By using the box 315, the efficiency of processing to be executed when an image file is loaded and only items to which a specific property is applied are picked up is improved, and the search efficiency during file access is improved. Further, by using the box 315, a collective operation is facilitated, for example, in the case of editing a file. For example, when the item property indicated in a property_index is a property indicating an image size, image items with the same size can be grouped and described. In addition, a plurality of image items to which image properties defined in the ItemPropertyContainerBox is represented by the box 315, thereby facilitating the metadata processing unit 110 to identify the plurality of images to which the common properties are applied.

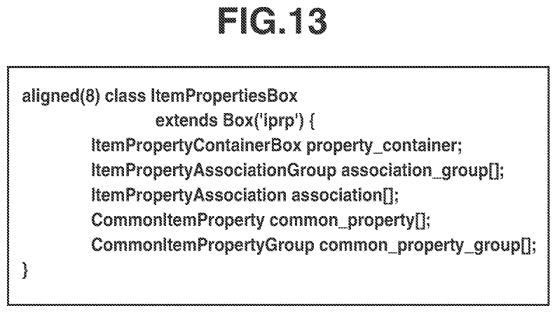

The ItemPropertyBox 310 includes a structure illustrated in FIG. 13 to store a box representing common properties. Specifically, the box 310 stores, the ItemPropertyAssociationBox inside an ItemPropertiesBox identified by the identifier iprp. The box 310 further stores the ItemPropertyContainerBox, the ItemPropertyAssociationGroupBox, the CommonItemPropertyBox, and the CommonItemPropertyGroupBox.

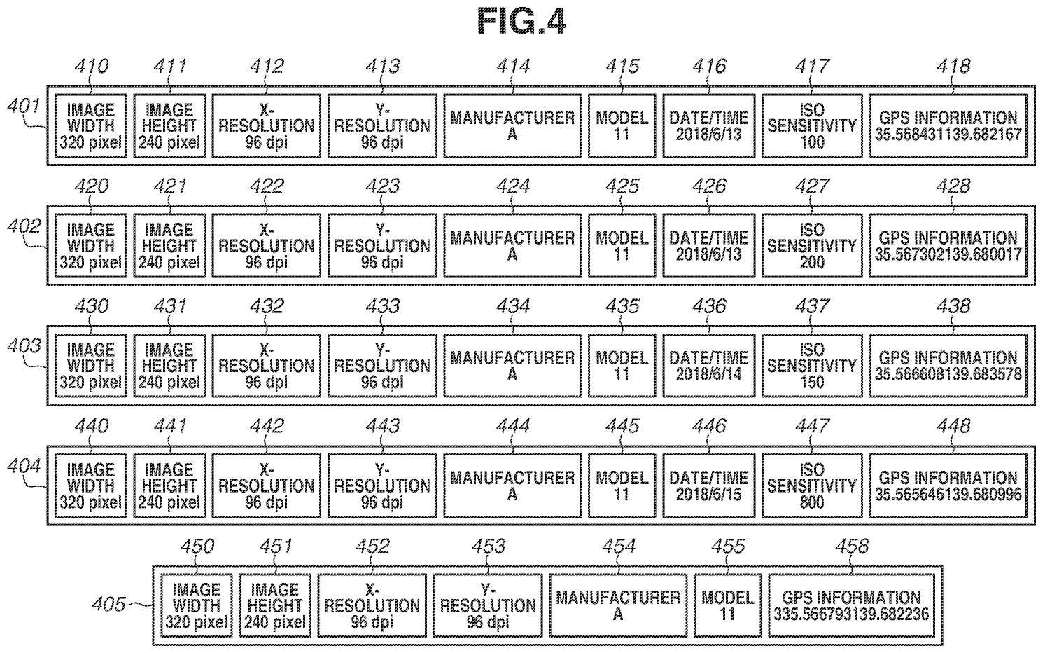

Next, a method for storing externally defined metadata Exif data) indicated by the boxes 319, 320, and 321 stored in the media data unit 303 as common metadata will be described with reference to FIGS. 4, 14, and 15.

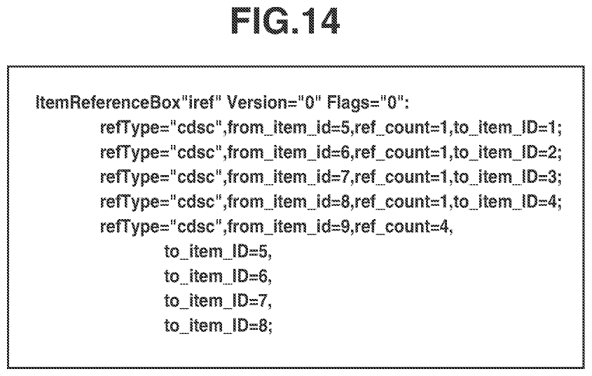

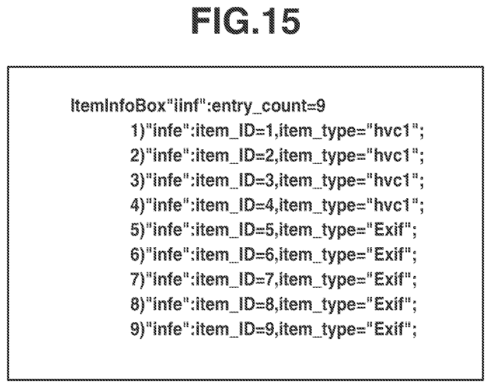

FIG. 14 is a description example of the ItemInformationBox 308 illustrated in FIG. 3. FIG. 15 illustrates a description example of the ItemReferenceBox 309 illustrated in FIG. 3. FIG. 4 illustrates Exif data blocks 401, 402, 403, 404, and 405. An ItemInformationBox illustrated in FIG. 15 is formed of nine entries, and an item_ID 1, item_ID 2, item_ID 3, and item_ID 4 indicate image items. The data block of which an item_ID is “5” corresponds to the Exif data block 401, the data block of which an item_ID is “6” corresponds to the Exif data block 402, the data block of which an item_ID is “7” corresponds to the Exif data block 403, the data block of which an item_ID is “8” corresponds to the Exif data block 404, and the data block of which an item_ID is “9” corresponds to the Exif data block 405. An ItemReferenceBox illustrated in FIG. 14 indicates a reference relationship between items. As seen from FIGS. 14 and 15, an item_ID 5 represents an Exif data block for the image corresponding to the item_ID 1. Similarly; an item_ID 6 represents an Exif data block for the image corresponding to the item_ID 2, an item_ID 7 represents an Exif data block for the image corresponding to the item_ID 3, and an item_ID 8 represents an Exif data block for the image corresponding to item_ID 4. An Item_ID 9 refers to the item_ID 5, item_ID 6, item_ID 7, and item_ID 8. This description indicates that the item_ID 9 represents an Exif data block obtained by extracting a common portion from the Exif data blocks indicated by the item_ID 5, item_ID 6, item_ID 7, and item_ID 8.

The Exif data block 401 illustrated in FIG. 4 includes Exif tags for an image width 410, an image height 411, an X-resolution 412, a Y-resolution 413, a manufacturer 414, a model 415, an image capturing date/time 416, an ISO sensitivity 417, and global positioning system (GPS) information 418. The same holds true for the Exif data blocks 402, 403, and 404. These tags are generated during image capturing. Further, editing processing or the like may be separately performed to add, change, or delete tags. The Exif data block 405 is a block for storing data that is common to the Exif data blocks 401, 402, 403, and 404. Image width areas 410, 420, 430, and 440 indicate the same value of 320 pixel, and thus the value “320 pixel” is stored in an image width tag 450 in the Exif data block 405. Similarly; image height areas 411, 421, 431, and 441 indicate the same value of 240 pixel, and thus the value “240 pixel” is stored in an image height tag 451 in the Exif data block 405, Further, “96 dpi” indicated by each of X-resolution areas 412, 422, 432, and 442 is stored in an area 452, and “96 dpi” indicated by each of Y-resolution areas 413, 423, 433, and 443 is stored in an area 453. “Manufacturer A” indicated by each of manufacturer name areas 414, 424, 434, and 444 is stored in an area 454, and “Model 11” indicated by each of model name areas 415, 425, 435, and 445 is stored in an area 455.

In contrast, the image capturing date/time varies from image to image. In the example of FIG. 4, areas 416 and 426 indicate “2018/6/13”, an area 436 indicates “2018/6/14”, and an area 446 indicates “2018/6/15”. The image capturing date/time is not stored in the Exif data block 405 that is obtained by extracting data common to the Exif data blocks, accordingly, Thus, in the example of FIG. 4, only metadata common to all image items is stored in the Exif data block 405. Further, ISO sensitivity areas 417, 427, 437, and 447 indicate different values, and thus the values are not stored in the Exif data block 405. In FIG. 4, time information is omitted in the date/time area.

However, in the example of FIG. 4, GPS information (positional information) indicated by areas 418, 428, 438, and 448 is stored in the Exif data block 405, as long as the values fall within a predetermined range even if the values do not completely match. This is because all the values in the GPS information areas 418, 428, 438; and 448 match indicating information about a specific location, although the values do not completely match. In other words, all the GPS information areas 418, 428, 438, and 448 indicate a location of Manufacturer A, and all the locations derived from a geocode or the like indicate Manufacturer A. In this regard, these pieces of information match with each other.

Therefore, the metadata processing unit 110 according to the present exemplary embodiment handles a plurality of pieces of GPS information that falls within a specific range as common metadata. Thus, some types of metadata (e.g., GPS information) can be stored in an area for storing common metadata even when the values do not completely match. The range of common metadata to be handled can be separately designated by the user, or can be appropriately determined according to a specific system setting or the like. In the example of FIG. 4, all pieces of GPS information on the premises of Manufacturer A are handled as common metadata, and GPS information stored in UPS information area 458 represents a representative point of Manufacturer A as indicated by a geocode or the like. For example, in a case of handling UPS information obtained in the Tokyo metropolitan area as common GPS information, positional information about the representative point of Tokyo is stored in the UPS information area 458. In the HEIF file according to the present exemplary embodiment, information indicating the granularity with which UPS information is handled is not stored, but instead the information may be stored in a file.

FIG. 4 illustrates an example of storing data common to all Exif data blocks of each image in a common Exif data block. However, an Exif data block common among two or more Exif data blocks can be stored in the common Exif data block. In this case, the Exif data block to be referenced may be defined in the ItemReferenceBox illustrated in FIG. 14. For example, in a case of extracting the common Exif data block corresponding only to the item_ID 5 and item_ID 6, “5” and “6” are stored in the to_item_ID. In this case, the image capturing date/time areas 416 and 426 indicate common Exif data, and thus are included in an extraction target. A plurality of Exif data blocks can be extracted as the common Exif data block, and original data from which the common Exif data block is extracted may overlap. For example, data common to the item_ID 5 and item_ID 6 and data common to the item_ID 5, item_ID 6, item_ID 7, and item_ID 8 may be used as extraction target.

Further, the metadata processing unit 110 according to the present exemplary embodiment extracts all common data in the Exif data blocks corresponding to each image, but instead may extract common data only for specific Exif data. For example, it may be determined whether only the image capturing date/time is common. Alternatively, for example, it may be determined whether the image capturing date/time item is common only for images with the image capturing date/time falling within a specific range, Thus, it may be determined whether metadata of a specific type is common, and it should be noted that there are a variety of methods for determining the specific type.

As described above, the image data storage device 101 according to the present exemplary embodiment extracts common metadata from the metadata (property information) associated with each of a plurality of images stored in the image file (HEIF file) conforming to the image file format. The image data storage device 101 stores the extracted metadata in the metadata area as common metadata. The image data storage device 101 may also store, in the HEIF file, information indicating whether the common metadata is common to all images, or is common to some of a plurality of images. If the common metadata is common to some of the images, item IDs for some of the images (identification information about the images) are stored. Also, for metadata (e.g., Exif data) based on external standards, the image data storage device 101 extracts common metadata from the metadata corresponding to each image, and holds the extracted metadata as common metadata. The processing load to be imposed when a plurality of images stored in the HEIF file is handled can thereby be reduced. The processing load can be reduced, for example, in the case of performing specific processing only on one or more images associated with specific metadata among the plurality of images stored in the HEIF file. Further, processing of searching for a specific image from among the plurality of images stored in the HEIF file can be performed with a low load. In addition, metadata corresponding to each image is shared and stored, which leads to a reduction in the size of the image file.

### Second Exemplary Embodiment

In the first exemplary embodiment, an example of extracting common metadata and storing the common metadata in an image file during image generation has been mainly described. In a second exemplary embodiment described below, an example of extracting common metadata from images or metadata already stored in an image file will be described in detail,

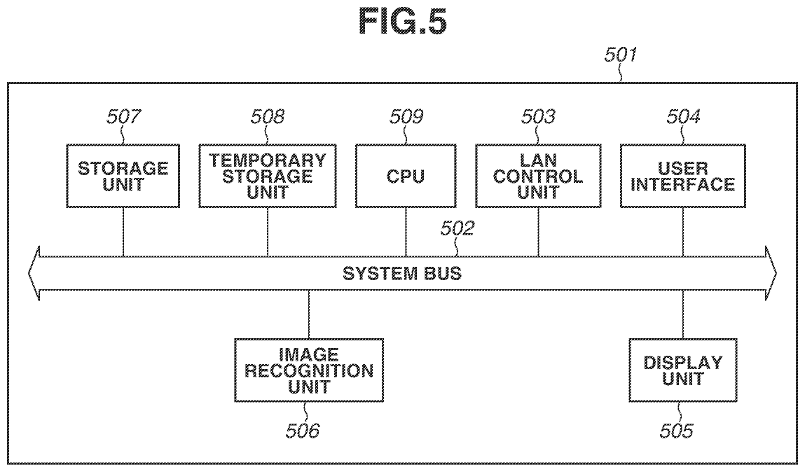

FIG. 5 illustrates a configuration of an image data storage device 501 according to the present exemplary embodiment. The image data storage device 501 illustrated in FIG. 5 is a device including a file editing function, such as a tablet PC, a desktop PC, or a server device that performs processing using a web service, such as a cloud service. The image data storage device 501 includes a system bus 502, and also includes a LAN control unit 503, a user interface 504, a display unit 505, and an image recognition unit 506, The image data storage device 501 further includes a storage unit 507, a temporary storage unit 508, and a CPU 509. Each of these units has a hardware configuration to be connected to the system bus 502. The system bus 502 transmits data between blocks connected thereto.

Programs to be executed by the CPU 509 include an operating system (OS), a driver, and an application. The CPU 509 controls an overall operation of the image data storage device 501, and performs processing for, for example, changing display of the display unit 505 and sending a connection instruction to the LAN control unit 503, based on an instruction input by the user via the user interface 504.

Programs to be executed by the CPU 509 are stored in the storage unit 507, or are received via the LAN control unit 503 to execute encoding or decoding processing on an input video image or an input image.

In a case of performing playback processing on a video image file or an image file by a user operation, the CPU 509 executes decoding, and the decoded data is played back as a video image or an image by the display unit 505. Programs to be executed by the CPU 509 include a program related to data processing in a format conforming to predetermined file format standards related to video images or images. The data processing can include format processing for storing metadata in an image file, processing for analyzing metadata stored in an image file, and image file editing processing. In a case of handling the HEIF file, the CPU 509 performs processing in a format conforming to HEIF. However, the format is not limited to HEIF. Data processing in a video image file format specified in the MPEG or the like, or data processing in a still image format, such as JPEG, may be performed. The storage unit 507 can be implemented by, for example, a hard disk, a Secure Digital (SD) card, CompactFlash®, a flash memory.

The image recognition unit 506 recognizes, for example, a person, an object, a scene based on an image or video image received from the CPU 509, and sends the result to the CPU 509. The temporary storage unit 508 is a main storage unit for the image data storage device 501, and is mainly used as a temporary data storage area when processing of each functional block is executed. The storage unit 507 is a nonvolatile storage unit that stores software programs to be executed by each functional block, Programs stored in the storage unit 507 are transferred to the temporary storage unit 508 and are read out and executed by each functional block. The LAN control unit 503 is a communication interface for connecting to a LAN, and executes communication control using a wired LAN or wireless LAN. In the present exemplary embodiment, the functional blocks are configured using different circuits, but instead one or more functional blocks can be executed by the CPU 509. The functions illustrated in FIG. 5 can be executed by being divided using a plurality of devices.

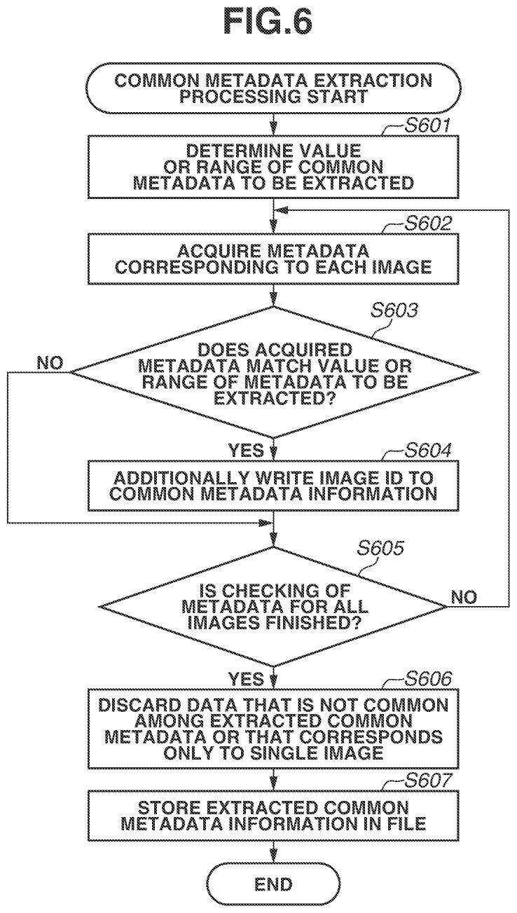

Next, a processing flow for editing an image file (HEIF file) conforming to an image file format will be described with reference to FIG. 6. Typically, this processing flow is started in response to an input of an editing instruction from the user.

In step S601, the CPU 509 determines the value, range, type, or the like of metadata to be extracted from among metadata associated with each of a plurality of images stored in the image file (HEIF file) conforming to the image file format. This determination can be made based on a user designation operation from the user interface, or can be made based on a predetermined system setting or the like. Moreover, a plurality of determinations can be made.

In step S602, the CPU 509 acquires metadata on each of the plurality of images stored in the HEIF file. The CPU 509 can process not only a single HEIF file, but also a plurality of HEIF files. The CPU 509 can process not only the HEIF file, but also a REG file or the like. The CPU 509 can acquire only metadata already recorded on the HEIF file, or can acquire metadata newly generated through editing processing performed by the image data storage device 501, or through processing performed by the image recognition unit 506.

In step S603, the CPU 509 determines whether the value of the metadata acquired in step S602 matches the value or range of the metadata determined in step S601. If the value of metadata matches the value or the range of the metadata (YES in step S603), the processing proceeds to step S604. If the value of the metadata does not match the value or range of the metadata (NO in step S603), the processing proceeds to step S605.

In step S604, the CPU 509 stores the item ID for identifying the matched image in the storage area for common metadata. In a case of processing a plurality of image files, an item ID for identifying an image item from the other image items is stored in a single HEIF file newly generated.

In step S605, the CPU 509 determines whether the processing on all images from which metadata is to be acquired is completed. If the processing is completed (YES in step S605), the processing proceeds to step S606. If the processing is not completed (NO in step S605), the processing returns to step S602 and the processing is repeated.

In step S606, the CPU 509 deletes metadata that is not common among the other images. In other words, the CPU 509 does not store metadata to be applied only to a single image as common metadata. In step S607, the CPU 509 stores the common metadata in the HEIF file. In this case, based on the common metadata and the image ID, the common metadata is stored in the HEIF file according to the formats illustrated in FIGS. 7 to 15. In the present exemplary embodiment, metadata corresponding only to a single image is not stored as common metadata, but instead metadata that is common to a number of images less than a predetermined threshold may not be stored as common metadata. In some cases, metadata that corresponds only to a single image can be stored in the area for storing common metadata. This configuration is effective, for example, in a case where only one image is stored in the HEIR file, or in a use case where an image item where specific metadata is recorded is to be promptly retrieved. In other words, information stored in the storage area for common metadata can be used as an index for an image associated with specific metadata.

As described above, the image data storage device 501 according to the present exemplary embodiment extracts common metadata from the generated image file, and generates a new HEIF file in which the common metadata is stored. With this configuration, an image file in which common metadata is stored can be generated from an image file on which common metadata is not recorded. The image data storage device 501 according to the present exemplary embodiment extracts common metadata from a plurality of images (including a video) stored in a plurality of image files (including a video file), and generates a new image file in which the common metadata is stored.

Thus, it is possible to generate a single HEIF file by editing processing on image files generated by a plurality of devices, or image files generated under different conditions. In this case, as described in the first exemplary embodiment, information indicating whether the common metadata is common to all image groups, or whether the common metadata is common to some of the image groups may be stored. If the common metadata is common to some of the image groups, an item ID for an image corresponding to the common metadata is further stored. Also, for metadata (e.g., Exif data) based on external standards, the image data storage device 501 extracts common metadata from metadata corresponding to each image, and holds the extracted metadata as common metadata. The processing load to be imposed when a plurality of images stored in the HEIF file is handled can thereby be reduced. For example, the processing load can be reduced in the case of performing specific processing only on one or more images associated with specific metadata among a plurality of images stored in the HEIF file. Further, processing of searching for a specific image from among the plurality of images stored in the HEIF file can be performed with a low load. In addition, metadata corresponding to each image is shared and stored, which leads to a reduction in the size of the image file.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g, application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image data storage device that stores a plurality of images in an image file conforming to an image file format, the image data storage device comprising:
an acquisition unit figured to acquire the plurality of images;
an identification unit configured to identify metadata common among two or more of the plurality of images acquired by the acquisition unit;
a storage unit configured to store the plurality of images acquired by the acquisition unit in the image file conforming to the image file format, and to store the metadata identified by the identification unit as common metadata in the image file conforming to the image file format; and
an output unit configured to output the image file in which the plurality of images and the metadata are stored by the storage unit.

2. The image data storage device according to claim 1, wherein the output unit outputs the image file to at least one of a display device configured to display an image based on the image file, a printing device configured to print an image based on the image file, a storage device configured to store the image file, and a storage medium configured to store the image file.

3. The image data storage device according to claim 1, wherein the image file format is a format specified in International Organization for Standardization (ISO)/International Electrotechnical Commission (IEC) 23008-12.

4. The image data storage device according to claim 1, wherein:
the acquisition unit acquires, as the plurality of images, a plurality of image files conforming to an ISO base media file format; and
the identification unit extracts property information to be stored in an item property box from the plurality of image files conforming to the ISO base media file format, and identifies the common metadata based on a result of the extraction.

5. The image data storage device according to claim 1, wherein:
the acquisition unit acquires a plurality of image files including exchangeable image file format (Exif) data as the plurality of images; and
the identification unit extracts Exif data from the plurality of image files, and identities the common metadata based on a result of the extraction.

6. The image data storage device according to claim 5, wherein in a case where a first value indicated by Exif data corresponding to a first image and a second value indicated by Exif data corresponding to a second image fall within a predetermined range, the identification unit identifies the first and second values as common metadata.

7. The image data storage device according to claim 6, wherein the first and second values are positional information indicated by global positioning system (GPS) information.

8. The image data storage device according to claim 1, wherein:
the image data storage device further comprises a recognition unit configured to perform recognition processing on the plurality of images acquired by the acquisition unit; and
the metadata is data generated based on a result of the recognition processing performed by the recognition unit.

9. The image data storage device according to claim 8, wherein the metadata generated based on the result of the recognition processing is at least one of scene information obtained by recognition processing on a scene in an image, and object information obtained by recognition processing on an object in an image.

10. The image data storage device according to claim 1, wherein the storage unit generates the image file in which the metadata identified by the identification unit and identification information about the two or more images associated with the metadata are stored.

11. The image data storage device according to claim 1, wherein the storage unit divides the metadata identified by the identification unit into groups, and generates the image file in which the metadata, identification information about each of the groups, and identification information about an image corresponding to each of the groups of the metadata are stored.

12. The image data storage device according to claim 1, wherein the storage unit divides the two or more images corresponding to the metadata identified by the identification unit into groups, and generates the image file in which the metadata, identification information about each of the groups, and identification information about the two or more images belonging to each of the groups are stored.

13. An image data storage method that stores a plurality of images into an image file conforming to an image file format, the image data storage method comprising:
acquiring the plurality of images;
identifying metadata common among two or more images of the plurality of images acquired in the acquiring;
storing the plurality of images acquired in the acquiring into an image file conforming to the image file format, and storing the metadata identified in the identifying into the image file conforming to the image file format as common metadata; and
outputting the image file in which the plurality of images and the metadata are stored in the storing.

14. Anon-transitory computer-readable storage medium storing instructions for causing a computer to perform an image data storage method that stores a plurality of images into an image file conforming to an image file format, the image data storage method comprising:
acquiring the plurality of images;
identifying metadata common among two or more images of the plurality of images acquired in the acquiring;
storing the plurality of images acquired in the acquiring into an image file conforming to the image file format, and storing the metadata identified in the identifying into the image file conforming to the image file format as common metadata; and
outputting the image file in which the plurality of images and the metadata are stored in the storing.
